(19) United States
(12) Patent Application Publication
(10) Pub. No.: US 2015/0119055 A1
(43) Pub. Date: Apr. 30, 2015

(54) D2D (DEVICE-TO-DEVICE) DISCOVERY METHOD AND RESOURCE ALLOCATION METHOD

(71) Applicant: ELECTRONICS AND TELECOMMUNICATIONS RESEARCH INSTITUTE, Daejeon (KR)

(72) Inventors: JaeSheung SHIN, Daejeon (KR); Mi Young YUN, Daejeon (KR); Sung-Min OH, Daejeon (KR); Changhee LEE, Seoul (KR); Ae-Soon PARK, Daejeon (KR)

(73) Assignee: ELECTRONICS AND TELECOMMUNICATIONS RESEARCH INSTITUTE, Daejeon (KR)

(21) Appl. No.: 14/526,673

(22) Filed: Oct. 29, 2014

(30) Foreign Application Priority Data
Oct. 31, 2013 (KR) 10-2013-0131546
Sep. 18, 2014 (KR) 10-2014-0124611

(51) Int. Cl. H04W 72/04; H04W 8/00

(52) U.S. Cl. CPC H04W 72/042; H04W 8/005
USPC 455/450

(57) ABSTRACT

A D2D (Device-to-Device) discovery method is provided which enables a first terminal within a first cell to discover a second terminal within a second cell without relay of a base station. The first terminal receives, from a first base station of the first cell, information about a first resource for D2D discovery through a SIB (System Information Block) or RRC (Radio Resource Control) message. The first terminal transmits a D2D discovery signal using the first resource.

### CROSS-REFERENCE TO RELATED APPLICATION

This application claims priority to and the benefit of Korean Patent Application No. 10-2013-0131546 and 10-2014-0124611 filed in the Korean Intellectual Property Office on Oct. 31, 2013 and Sep. 18, 2014, the entire contents of which are incorporated herein by reference.

### BACKGROUND OF THE INVENTION

(a) Field of the Invention

The present invention relates to a D2D discovery method for a terminal and a resource allocation method for a base station.

(b) Description of the Related Art

Currently, 3GPP (3rd Generation Partnership Project) standardization for D2D (Device-to-Device) communication, which enables a terminal to directly communicate with other terminals without relay of a base station, is underway.

The D2D scenario so far agreed upon in the 3GPP meetings is as shown in FIG. 1. Specifically, (A) of FIG. 1 shows Scenario 1A, which assumes that both a terminal 100 and a terminal 200 are located out of coverage of a base station. (B) of FIG. 1 shows Scenario 1B, which assumes that a terminal 100 is located in the coverage of a base station 300 and a terminal 200 is located out of the coverage of the base station 300. (C) of FIG. 1 shows Scenario 1C, which assumes that both the terminal 100 and the terminal E 200 are located in the coverage of the base station 300. (D) of FIG. 1 shows Scenario 1D, which assumes that the terminal 100 is located in the coverage of the base station 300 and the terminal 200 is located in the coverage of a base station 400. That is, Scenarios 1A to 1D are as shown in the following Table 1.

TABLE 1

| Scenario | terminal 100 | terminal 200 |
|---|---|---|
| 1A: Out of Coverage | Out of Coverage | Out of Coverage |
| 1B: Partial Coverage | In Coverage | Out of Coverage |
| 1C: In Coverage-Single-Cell | In Coverage | In Coverage |
| 1D: In Coverage-Multi-Cell | In Coverage | In Coverage |

According to the document TR 36.843 drafted through the RAN2 #83bis meeting on September, 2013, it was agreed that focus should be on D2D discovery mechanisms (e.g., Scenarios 1C and 1D) under the in-coverage environment, as shown in the following Table 2.

TABLE 2

| | | |
|---|---|---|
| 6. D2D Discovery | 6.3.1 General | RAN2 will focus on a D2D Discovery mechanism for |
| | | in Coverage (Scenario 1C and 1D) |
| | | UE needs to be allowed by the NW to transmit discovery |
| | | messages in both RRC_IDLE and RRC_CONNECTED |
| | | modes. |
| | | a) The NW needs to be in control of the resources and |
| | | transmission mode (RRC_CONNECTED and/or RRC_IDLE) |
| | | that the UEs may use to transmit Discovery signals. |
| | | b) The details of resource allocation (Type 1 or Type2; SIB or |
| | | dedicated) are FFS. |
| | | c) Editor's note: NW should have the option to select the |
| | | preferred configuration mode (RRC_IDLE or |
| | | RRC_CONNECTED) for transmission and reception of |
| | | discovery messages. |
| | 6.3.3 RRM | It is possible for UEs to receive D2D discovery message |
| | Aspect | while being RRC_IDLE and RRC_CONNECTED. |
| | | a) If the UE cannot interpret (in AS or higher layers) the |
| | | received D2D discovery message, it may or may not establish |
| | | an RRC Connection in order to verify the content e.g. with an |
| | | application server. |
| | | Transmission of discovery messages should be supported in |
| | | RRC_IDLE mode and in RRC_CONNECTED mode. |

The types of resource allocation and provision of D2D discovery agreed upon up to now by 3GPP are roughly divided into Type 1 and Type 2, and Type 2 is subdivided into Type 2A and Type 2B.

TABLE 3

| | |
|---|---|
| Type 1 | a discovery procedure where resources for discovery signal |
| | transmission are allocated on a non UE specific basis. |
| | Resources can be for all UEs or group of UEs. |
| Type 2 | a discovery procedure where resources for discovery signal |
| | transmission are allocated on a per UE specific basis. |
| | Type 2A: |
| | Resources are allocated for each specific transmission |
| | instance of discovery signals |
| | Type 2B: |
| | Resources are semi-persistently allocated for discovery |
| | signal transmission |

As in Table 3, the discovery procedure of Type 1 is to allocate resources to all terminals or terminal groups within a cell, rather than to a specific terminal. The discovery procedure of Type 2 is to allocate resources to a specific terminal. Specifically, the discovery procedure of Type 2A is to dynamically allocate resources each time a signal for discovery is transmitted, and the discovery procedure of Type 2B is to allocate fixed resources for a predetermined length of time.

A discovery between the terminal 100 and the terminal 200 can be performed in such a manner that one terminal 100 receives resources allocated from a base station 300 and a neighboring terminal 200 finds the corresponding resources to properly receive the discovery signal.

In Scenario 1C (Intra-Cell), resources are allocated by one base station 300, and all the terminals 100 and 200 within the cell can share information about the allocated resources. Thus, the neighboring terminal 200 can find the corresponding resources and properly receive the discovery signal sent from the terminal 100.

In Scenario 1D (Inter-Cell), on the other hand, unless difference resources are allocated by different base stations 300 and 400 and information about the allocated resources are transmitted to a neighboring cell, the terminal 200 within the neighboring cell cannot find the corresponding resources and therefore cannot properly receive the discovery signal sent from the terminal 100 within the opposing cell.

The above information disclosed in this Background section is only for enhancement of understanding of the background of the invention and therefore it may include information that does not form the prior art that is already known in this country to a person of ordinary skill in the art.

### SUMMARY OF THE INVENTION

The present invention has been made in an effort to provide a method and apparatus for making a proper discovery when terminals belong to different cells.

An exemplary embodiment of the present invention provides a D2D (Device-to-Device) discovery method which enables a first terminal within a first cell to discover a second terminal within a second cell without relay of a base station. The D2D discovery method includes: receiving, from a first base station of the first cell, information about a first resource for D2D discovery through a SIB (System Information Block) or RRC (Radio Resource Control) message; and transmitting a D2D discovery signal using the first resource.

The first resource may be used for D2D discovery commonly by the first base station and a second base station of the second cell.

The receiving of the first resource information may include receiving, from the first base station, the SIB including the information about the first resource pre-defined by the first base station and the second base station.

The first resource may be allocated to the first terminal and a third terminal within the first cell for D2D discovery.

The receiving of the first resource information may include, when the first terminal is located in a boundary or overlapping area of the first and second cells, receiving, from the first base station, the information about the first resource pre-configured for the boundary or overlapping area by the first and second base stations through the RRC message.

The D2D discovery method may further include, prior to the receiving of the first resource information, transmitting, to the first base station, at least one of location information of the first terminal and a measurement result of received signal strength.

Another exemplary embodiment of the present invention provides a D2D discovery method which enables a first terminal within a first cell to discover a second terminal within a second cell without relay of a base station. The D2D discovery method includes: receiving, from the first base station, information about a first resource used for D2D discovery by a first base station of the first cell and information about a second resource used for D2D discovery by a second base station of the second cell, through a SIB or RRC message; and transmitting a first D2D discovery signal using the first resource.

The D2D discovery method may further include receiving a second D2D discovery signal by scanning the first resource and the second resource.

The first resource information and the second resource information may be shared between the first base station and the second base station through signaling between the first base station and the second base station.

The first resource information and the second resource information may be shared between the first base station and the second base station through a SON (Self Organizing Network) function.

The first resource may be allocated to the first terminal and a third terminal within the first cell for D2D discovery, and the second resource may be allocated to the second terminal and a fourth terminal within the second cell for D2D discovery.

The receiving of the first resource information and the second resource information may include receiving, from the first base station, the SIB including the first resource information and the second resource information.

The first base station and the second base station may be macro base stations.

The second resource may include a third resource allocated to the second terminal for D2D discovery and a fourth resource allocated to a fourth terminal within the second cell for D2D discovery.

The receiving of the first resource information and the second resource information may include receiving, from the first base station, the RRC message including the first resource information and the second resource information.

The first resource may be a different resource than a resource allocated to a third terminal within the first cell for D2D discovery.

Yet another exemplary embodiment of the present invention provides a method for a first base station of a first cell to allocate resources for D2D discovery. The resource allocation method includes: transmitting, to a second base station of a second cell, information about a first resource used for D2D discovery by the first base station; receiving, from the second base station, information about a second resource used for D2D discovery by the second base station; and transmitting, to a first terminal within the first cell, a SIB or RRC message including the first resource information and the second resource information.

The receiving from the second base station may include obtaining the second resource information through a SON function.

The transmitting to the first terminal may include: allocating the first resource, which is the same as the resource allocated to a second terminal within the first cell, to the first terminal; and broadcasting the SIB including the first resource information and the second resource information.

### BRIEF DESCRIPTION OF THE DRAWINGS

FIG. 1 is a view showing D2D scenarios.

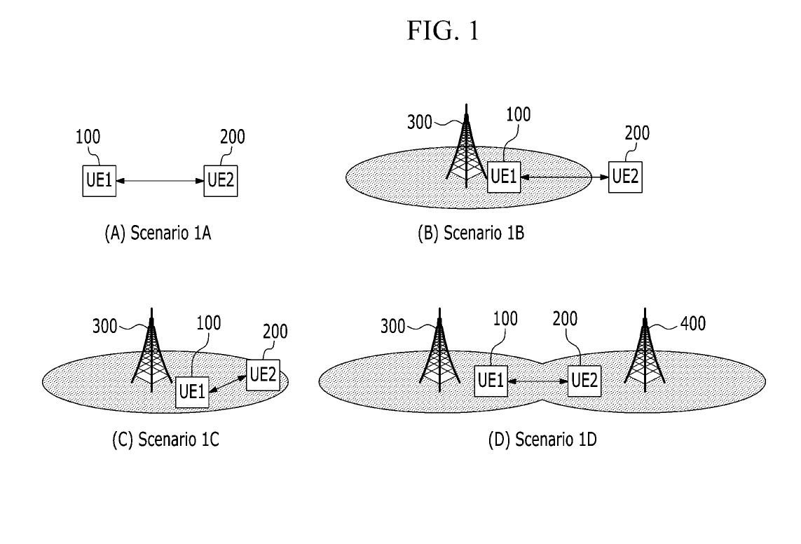

FIG. 2 is a view showing an example where terminals cannot properly perform discovery in Scenario 1 D.

FIG. 3 is a view showing an exemplary embodiment of the present invention in which terminals perform discovery of Type 1 over a common discovery resource.

FIG. 4 is a flowchart showing a procedure for the terminals of FIG. 3 to perform D2D discovery over the common discovery resource.

FIG. 5 is a view showing another exemplary embodiment of the present invention in which terminals perform discovery of Type 1 over dedicated resources.

FIG. 6 is a flowchart showing a procedure for the terminals of FIG. 5 to perform D2D discovery over dedicated resources.

FIG. 7 is a view showing yet another exemplary embodiment of the present invention in which terminals perform discovery of Type 2 over dedicated resources.

FIG. 8 is a flowchart showing a procedure for the terminals of FIG. 7 to perform D2D discovery over dedicated resources.

FIG. 9 is a view showing a further exemplary embodiment of the present invention in which terminals perform discovery of Type 2 over a pre-configured resource.

FIG. 10 is a view showing the configuration of a terminal according to an exemplary embodiment of the present invention.

FIG. 11 is a view showing the configuration of a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., or may include all or part of the MT, the MS, the AMS, the HR-MS, the SS, the PSS, the AT, the UE, etc.

A base station (BS) may designate an advanced base station (ABS), a high reliability base station (HR-BS), a nodeB, an evolved nodeB (eNodeB), an access point (AP), a radio access station (RAS), a base transceiver station (BTS), a mobile multihop relay (MMR-BS), a relay station (RS) serving as a base station, a high reliability relay station (HR-RS) serving as a base station, a small base station, etc., and may include all of part of the functions of the ABS, the nodeB, the eNodeB, the AP, the RAS, the BTS, the MMR-BS, the RS, the HR-RS, the small base station, etc.

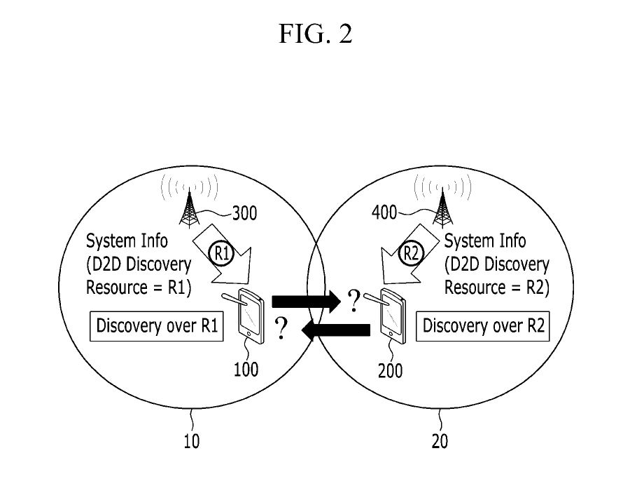

FIG. 2 is a view showing an example where terminals 100 and 200 cannot properly perform discovery in Scenario 1D.

Specifically, if a base station 300 allocates a resource R1 for D2D discovery to the terminal 100 within a cell 10 of the base station 300 and the terminal 100 transmits a discovery signal over the discovery resource R1, the terminal 200 does not have information about the resource R1 used for D2D discovery and therefore cannot find the discovery resource R1 and properly receive the discovery signal. If a base station 400 likewise allocates a resource R2 for D2D discovery to the terminal 200 within a cell 20 of the base station 400 and the terminal 200 transmits a discovery signal over the discovery resource R2, the terminal 100 does not have information about the resource R2 used for D2D discovery and therefore cannot find the discovery resource R2 and properly receive the discovery signal.

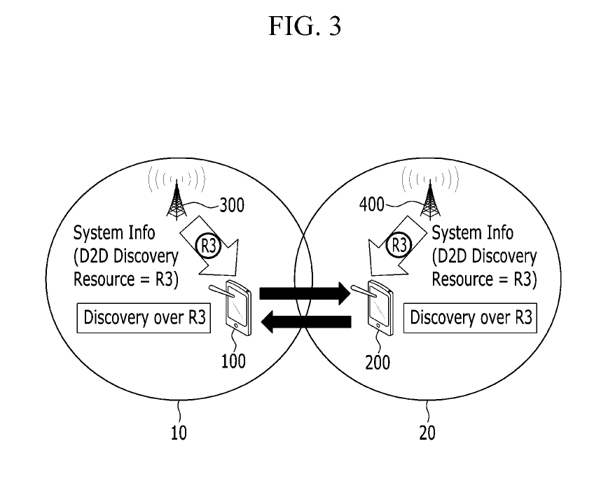

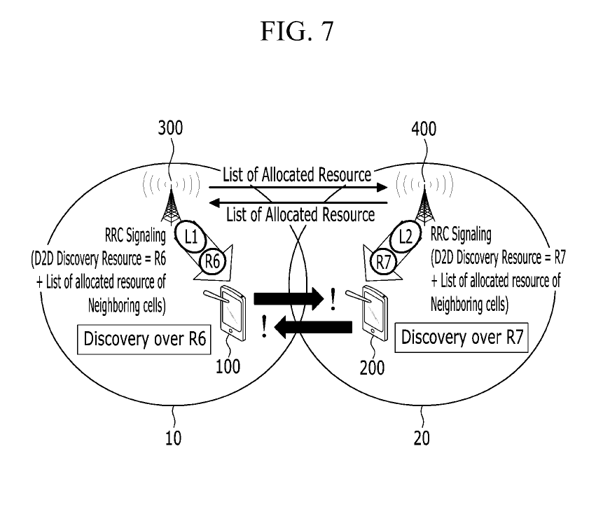

Methods for the terminals 100 and 200 to properly perform D2D discovery of Type 1 even if they are located in difference cells 10 and 20, including a resource allocation method and an allocated resource information provision method, will be described in detail with reference to FIGS. 3 to 6. Methods for the terminals 100 and 200 to properly perform D2D discovery of Type 2 even if they are located in difference cells 10 and 20, including a resource allocation method and a allocated resource information provision method, will be described in detail with reference to FIGS. 7 to 9.

FIG. 3 is a view showing an exemplary embodiment of the present invention in which the terminals 100 and 200 perform discovery of Type 1 over a common discovery resource R3. In discovery of Type 1, the base station 300 may allocate the same resource to every terminal within the cell 10 or a group of terminals within the cell 10 for the sake of D2D discovery.

Both the base stations 300 and 400 of the system predefine a common discovery resource (System-Wide Common D2D Discovery Resource) R3 which is commonly used for D2D discovery.

The base stations 300 and 400 broadcast a SIB (System Information Block) including information about the common discovery resource R3. The base stations 300 and 400 periodically broadcast the SIB.

All the terminals within the cells 10 and 20 perform a procedure for D2D discovery over the common discovery resource R3.

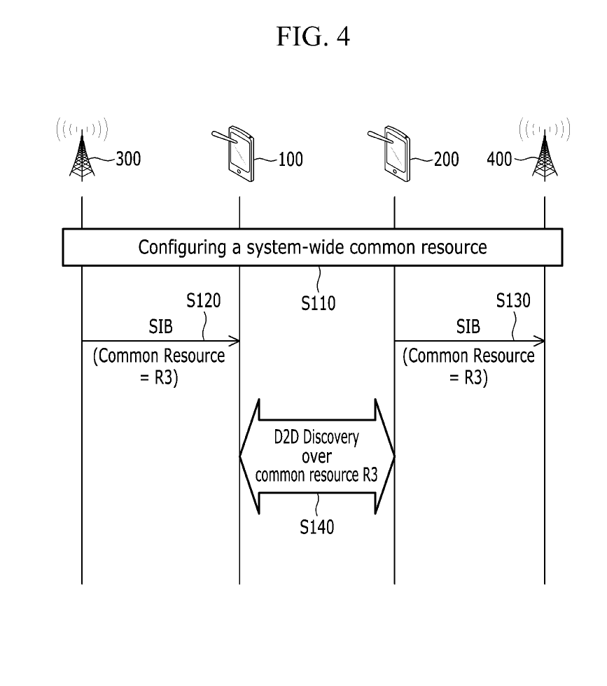

FIG. 4 is a flowchart showing a procedure for the terminals 100 and 200 of FIG. 3 to perform D2D discovery over the common discovery resource R3.

The base stations 300 and 400 pre-configure a common resource R3 for D2D discovery (S110).

The base stations 300 and 400 periodically broadcast a SIB including information about the common discovery resource R3 (S120 and 130).

The terminals 100 and 200 receive the SIB, extract the information about the common discovery resource R3, and transmit a D2D discovery signal over the common discovery resource R3 (S140). Next, the terminals 100 and 200 receive the D2D discovery signal by scanning the common discovery resource R3.

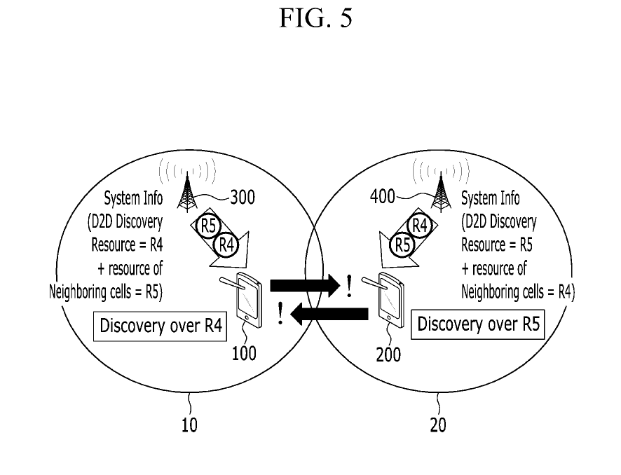

FIG. 5 is a view showing another exemplary embodiment of the present invention in which the terminals 100 and 200 perform discovery of Type 1 over dedicated resources R4 and R5.

The base stations 300 and 400 define resources R4 and R5 dedicated for D2D discovery. Specifically, FIG. 5 illustrates an example where the base station 300 uses the resource R4 for D2D discovery and the base station 400 uses the resource R5 for D2D discovery.

The base stations 300 and 400 share information about the discovery resources R4 and R5 with neighboring base stations. Specifically, the base station 300 and the base station 400 may share the information about the discovery resources R4 and R5 through signaling. Alternatively, the base station 300 and the base station 400 may share the information about the discovery resources R4 and R5 through a SON (Self Organizing Network) function.

The base stations 300 and 400 broadcast a SIB including the information about the discovery resources R4 and R5. Specifically, the base station 300 includes both the information about the discovery resource R4 allocated for the cell 10 and the information about the discovery resource R5 allocated for the neighboring cell 20 in a SIB and broadcasts the SIB. The base station 400 likewise includes both the information about the discovery resource R5 allocated for the cell 20 and the information about the discovery resource R4 allocated for the neighboring cell 10 in a SIB and broadcasts the SIB.

The terminal 100 transmits a D2D discovery signal over the discovery resource R4 allocated for the cell 10. Also, the terminal 100 receives a D2D discovery signal generated in its own cell 10 or the neighboring cell 20 by scanning the discovery resource R4 and the discovery resource R5 allocated for the neighboring cell 20. Likewise, the terminal 200 transmits a D2D discovery signal over the discovery resource R5 allocated for the cell 20, and receives a D2D discovery signal by scanning the discovery resource R5 and the discovery resource R4 allocated for the neighboring cell 10.

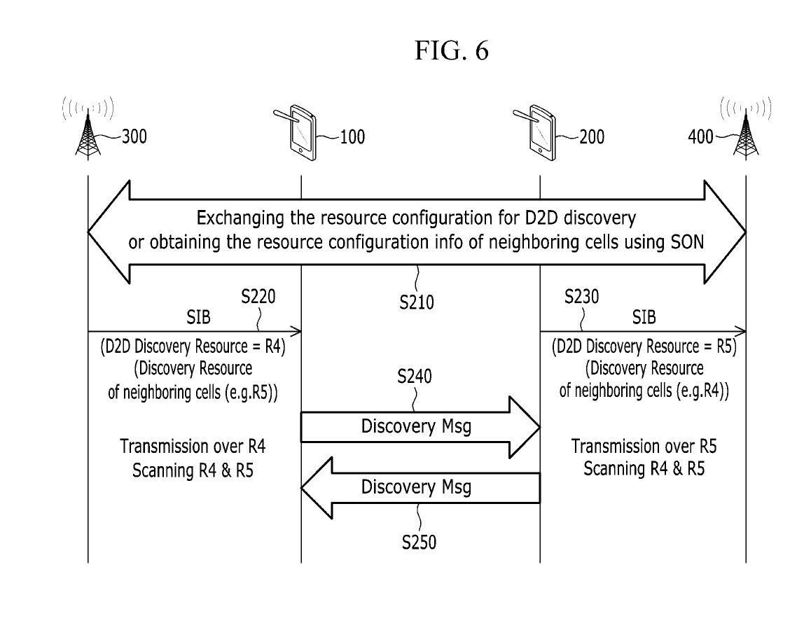

FIG. 6 is a flowchart showing a procedure for the terminals 100 and 200 of FIG. 5 to perform D2D discovery over dedicated resources.

The base stations 300 and 400 share resource configuration information for D2D discovery (S210). Specifically, the base stations 300 and 400 may exchange resource configuration information for D2D discovery with each other. Alternatively, the base stations 300 and 400 may obtain resource configuration information for D2D discovery of neighboring cells by using the SON function.

The base station 300 periodically broadcasts a SIB including information about the discovery resource R4 allocated for its own cell 10 and information about the discovery resource R5 for the neighboring cell 20 obtained in the step S210 (S220). The base station 400 likewise periodically broadcasts a SIB including information about the discovery resource R5 allocated for its own cell 20 and information about the discovery resource R4 for the neighboring cell 10 obtained in the step S220 (S230).

The terminal 100 transmits a D2D discovery signal over the discovery resource R4 (S240). Also, the terminal 100 receives a D2D discovery signal by scanning the discovery resource R4 and the discovery resource R5. Likewise, the terminal 200 transmits a D2D discovery signal over the discovery resource R5 (S250), and receives a D2D discovery signal by scanning the discovery resource R4 and the discovery resource R5.

FIG. 7 is a view showing yet another exemplary embodiment of the present invention in which the terminals 100 and 200 perform discovery of Type 2 over dedicated resources R6 and R7. In discovery of Type 2, the base station 300 may allocate the same resource or different resources to the terminals within the cell 10 for the sake of D2D discovery. For example, the base station 300 may allocate a discovery resource R6 to the terminal 100 within the cell 10 and a resource different than the discovery resource R6 to the other terminals within the cell 10.

The base stations 300 and 400 define dedicated resources R6 and R7 for D2D discovery. Specifically, FIG. 7 illustrates an example where the base station 300 allocates the resource R6 to the terminal 100 for D2D discovery and the base station 400 allocates the resource R7 to the terminal 200 for D2D discovery.

The base stations 300 and 400 periodically share information L1 and L2 about the defined resources with neighboring base stations. In an example, if the base station 300 allocates the discovery resource R6 to the terminal 100 and a discovery resource (hereinafter, ‘discovery resource R9’) different than the discovery resource R6 to the other terminals within the cell 10, it may transmit a discovery resource list L2 including information about the discovery resource R6 and the discovery resource R9 to the base station 400. In another example, if the base station 400 allocates the discovery resource R7 to the terminal 200 and a discovery resource (hereinafter, ‘discovery resource R10’) different than the discovery resource R7 to the other terminals within the cell 20, it may transmit a discovery resource list L1 including information about the discovery resource R7 and the discovery resource R10 to the base station 300.

The base stations 300 and 400 transmit an RRC (Radio Resource Control) signaling message including information about the resource allocated for its own cell and information about the resource allocated for the neighboring cell. Specifically, the base station 300 may include the information about the discovery resource R6 allocated to the terminal 100 and the discovery resource list L1 received from the base station 400 in an RRC signaling message and transmit the RRC signaling message to the terminal 100. The base station 400 may likewise include the information about the discovery resource R6 allocated to the terminal 200 and the discovery resource list L2 received from the base station 300 in an RRC signaling message and transmit the RRC signaling message to the terminal 200.

The terminal 100 transmits a D2D discovery signal over the allocated discovery resource R6. Also, the terminal 100 receives a D2D discovery signal by scanning the discovery resource R6 and the resources included in the discovery resource list L1. Likewise, the terminal 200 transmits a D2D discovery signal over the allocated discovery resource R7, and receives a D2D discovery signal by scanning the discovery resource R7 and the resources included in the discovery resource list L2.

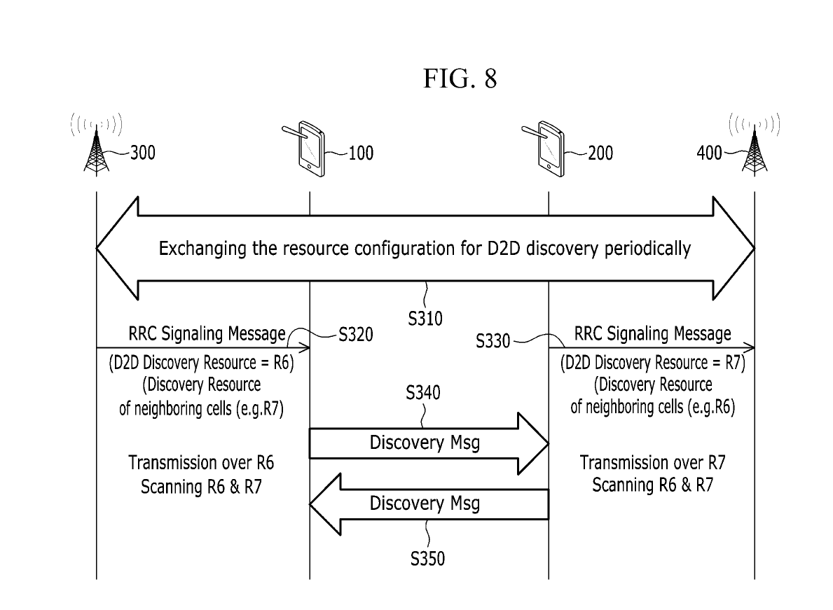

FIG. 8 is a flowchart showing a procedure for the terminals 100 and 200 of FIG. 7 to perform D2D discovery over dedicated resources R6 and R7.

The base stations 300 and 400 periodically exchange resource configurations for D2D discovery (S310).

The base station 300 transmits an RRC signaling message including information about the discovery resource R6 allocated to the terminal 100 and a discovery resource list L1 received from the base station 400 to the terminal 100 (S320). The base station 400 likewise transmits an RRC signaling message including information about the discovery resource R7 allocated to the terminal 200 and a discovery resource list L2 received from the base station 300 in the step S310 to the terminal 200 (S330). The discovery resource list L1 includes the discovery resource R7, and the discovery resource list L2 includes the discovery resource R6.

The terminal 100 transmits a D2D discovery signal over the allocated discovery resource R6 (S340). Also, the terminal 100 receives a D2D discovery signal by scanning the discovery resource R6 and the resource R7 included in the discovery resource list L1. The terminal 200 likewise transmits a D2D discovery signal over the allocated discovery resource R7 (S350), and receives a D2D discovery signal by scanning the discovery resource R7 and the resource R6 included in the discovery resource list L2.

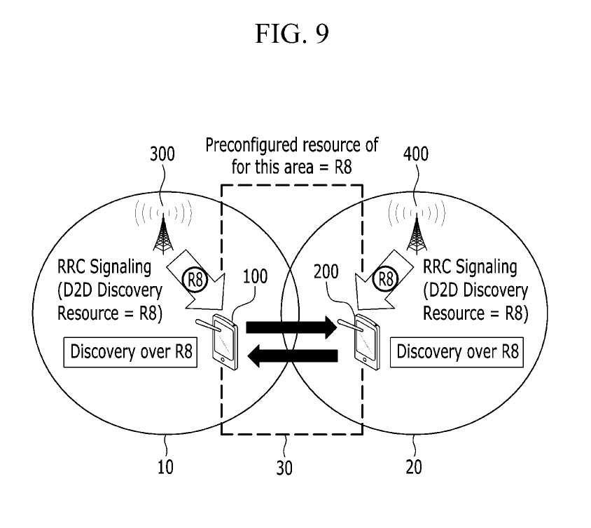

FIG. 9 is a view showing a further exemplary embodiment of the present invention in which the terminals 100 and 200 perform discovery of Type 2 over a pre-configured resource R8.

The base stations 300 and 400 pre-define a D2D discovery resource R8 for a boundary area 30 of cells 100 and 200 or an overlapping area 30 of their own cell and another cell. The first area 30 includes the boundary area of the cells 100 and 200 and the overlapping area.

Upon detecting that the terminals 100 and 200 are located in the first area 30 based on location information of the terminals 100 and 200, a measurement report, etc., the base stations 300 and 400 allocate a resource R8 pre-configured for D2D discovery to the terminals 100 and 200. For example, the terminal 100 may transmit its location information, a measurement result of received signal strength, etc., to the base station 300. The base station 300 determines whether the terminal 100 is located in the first area 30 or not, based on information received from the terminal 100. If the terminal 100 is located in the first area 30, the base station 300 allocates the discovery resource R8 pre-configured for the first area 30 to the terminal 100.

The base stations 300 and 400 transmit an RRC signaling message including information about the discovery resource R8 allocated to the terminals 100 and 200 to the terminals 100 and 200. For example, if the base station 300 allocates the discovery resource R8 to the terminal 100 located in the first area 30, it may include the information about the discovery resource R8 in an RRC signaling message and transmit the RRC signaling message to the terminal 100.

The terminals 100 and 200 perform a D2D discovery procedure by using the information about the discovery resource R8 included in the RRC signaling message. Specifically, the terminal 100 located in the first area 30 transmits a D2D discovery signal over the allocated discovery resource R8. Also, the terminal 100 receives a D2D discovery signal by scanning the discovery resource R8. The terminal 200 located in the first area 30 likewise transmits a D2D discovery signal over the allocated discovery resource R8, and receives a D2D discovery signal by scanning the discovery resource R8.

When compared with the exemplary embodiment of FIG. 7, the exemplary embodiment of FIG. 9 can reduce the overhead incurred by the base stations 300 and 400 exchanging discovery resource information and downsize the RRC signaling message.

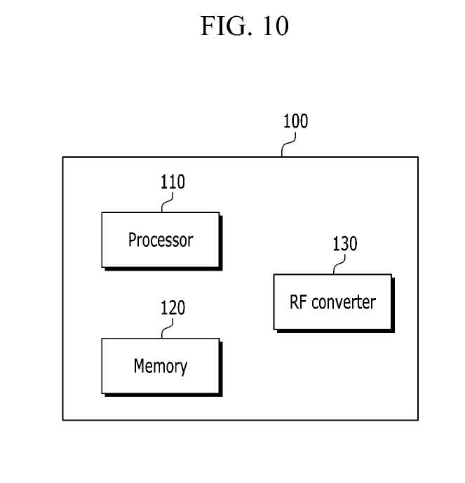

FIG. 10 is a view showing the configuration of the terminal 100 according to an exemplary embodiment of the present invention. The terminal 200 may be configured in the same manner as the terminal 100.

Specifically, the terminal 100 includes a processor 110, a memory 120, and an RF (Radio Frequency) converter 130.

The processor 110 may be configured in such a manner that the procedures, functions, and methods related to the terminals 100 and 200 explained in FIGS. 3 to 9 are implemented.

The memory 120 is connected to the processor 110, and stores various information related to the operation of the processor 110.

The RF converter 130 is connected to the processor 110, and sends or receives a radio signal. The terminal 100 may have a single antenna or multiple antennas.

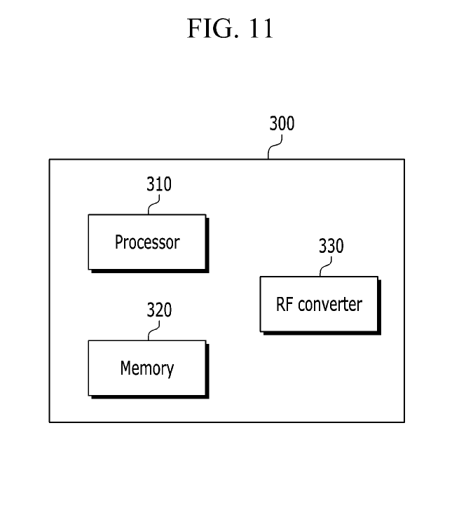

FIG. 11 is a view showing the configuration of the base station 300 according to an exemplary embodiment of the present invention. The base station 400 may be configured in the same manner as the base station 300.

Specifically, the base station 300 includes a processor 310, a memory 320, and an RF (Radio Frequency) converter 330.

The processor 310 may be configured in such a manner that the procedures, functions, and methods related to the base stations 300 and 400 explained in FIGS. 3 to 9 are implemented.

The memory 320 is connected to the processor 310, and stores various information related to the operation of the processor 310.

The RF converter 330 is connected to the processor 310, and sends or receives a radio signal. The base station 300 may have a single antenna or multiple antennas.

The base stations 300 and 400 may be macro base stations.

According to an embodiment of the present invention, discovery of Type 1 and discovery of Type 2 can be properly performed even when terminals belong to different cells.

According to an exemplary embodiment of the present invention, a terminal can properly discover an opposing terminal within a different macro base station area.

While an exemplary embodiment of the present invention has been described in detail, the protection scope of the present invention is not limited to the foregoing embodiment, and it will be appreciated by those skilled in the art that various modifications and improvements using the basic concept of the present invention defined in the appended claims are also included in the protection scope of the present invention.

What is claimed is:

1. A D2D (Device-to-Device) discovery method which enables a first terminal within a first cell to discover a second terminal within a second cell without relay of a base station, the method comprising:
receiving, from a first base station of the first cell, information about a first resource for D2D discovery through a SIB (System Information Block) or RRC (Radio Resource Control) message; and
transmitting a D2D discovery signal using the first resource,
wherein the first resource is used for D2D discovery commonly by the first base station and a second base station of the second cell.

2. The method of claim 1, wherein the receiving of the first resource information comprises receiving, from the first base station, the SIB including the information about the first resource pre-defined by the first base station and the second base station,
wherein the first resource is allocated to the first terminal and a third terminal within the first cell for D2D discovery.

3. The method of claim 1, wherein the receiving of the first resource information comprises, when the first terminal is located in a boundary or overlapping area of the first and second cells, receiving, from the first base station, the information about the first resource pre-configured for the boundary or overlapping area by the first and second base stations through the RRC message.

4. The method of claim 3, further comprising, prior to the receiving of the first resource information, transmitting, to the first base station, at least one of location information of the first terminal and a measurement result of received signal strength.

5. A D2D (Device-to-Device) discovery method which enables a first terminal within a first cell to discover a second terminal within a second cell without relay of a base station, the method comprising:
receiving, from the first base station, information about a first resource used for D2D discovery by a first base station of the first cell and information about a second resource used for D2D discovery by a second base station of the second cell, through a SIB or RRC message; and
transmitting a first D2D discovery signal using the first resource.

6. The method of claim 5, further comprising receiving a second D2D discovery signal by scanning the first resource and the second resource.

7. The method of claim 5, wherein the first resource information and the second resource information are shared between the first base station and the second base station through signaling between the first base station and the second base station.

8. The method of claim 5, wherein the first resource information and the second resource information are shared between the first base station and the second base station through a SON (Self Organizing Network) function.

9. The method of claim 5, wherein the first resource is allocated to the first terminal and a third terminal within the first cell for D2D discovery, the second resource is allocated to the second terminal and a fourth terminal within the second cell for D2D discovery, and
the receiving of the first resource information and the second resource information comprises receiving, from the first base station, the SIB including the first resource information and the second resource information.

10. The method of claim 5, wherein the first base station and the second base station are macro base stations.

11. The method of claim 5, wherein the second resource comprises a third resource allocated to the second terminal for D2D discovery and a fourth resource allocated to a fourth terminal within the second cell for D2D discovery, and the receiving of the first resource information and the second resource information comprises receiving, from the first base station, the RRC message including the first resource information and the second resource information.

12. The method of claim 11, wherein the first resource is a different resource than a resource allocated to a third terminal within the first cell for D2D discovery.

13. A method for a first base station of a first cell to allocate resources for D2D (Device-to-Device) discovery, the method comprising:
transmitting, to a second base station of a second cell, information about a first resource used for D2D discovery by the first base station;
receiving, from the second base station, information about a second resource used for D2D discovery by the second base station; and
transmitting, to a first terminal within the first cell, a SIB or RRC message including the first resource information and the second resource information.

14. The method of claim 13, wherein the receiving from the second base station comprises obtaining the second resource information through a SON (Self Organizing Network) function.

15. The method of claim 13, wherein the transmitting to the first terminal comprises:
allocating the first resource, which is the same as a resource allocated to a second terminal within the first cell, to the first terminal; and
broadcasting the SIB including the first resource information and the second resource information.

16. The method of claim 13, wherein the second resource comprises a third resource allocated to a second terminal within the second cell for D2D discovery and a fourth resource allocated to a third terminal within the second cell for D2D discovery, and
the transmitting to the first terminal comprises transmitting, to the first terminal, the RRC message including the first resource information and the second resource information.

17. The method of claim 16, further comprising:
allocating a fifth resource, different from the first resource allocated to the first terminal, to a fourth terminal within the first cell for D2D discovery; and
transmitting information about the fifth resource to the second base station.

18. The method of claim 16, wherein the receiving from the second base station comprises periodically receiving the second resource information from the second base station.

19. The method of claim 13, wherein the first base station and the second base station are macro base stations.
